(19) United States
(12) Patent Application Publication
(10) Pub. No.: US 2010/0143073 A1
(43) Pub. Date: Jun. 10, 2010

(54) HEXAGONAL SCREW HEAD

(76) Inventor: Chun-Leon CHEN, Changhua City (TW)

Correspondence Address: Guice Patents PLLC, 12647 Galveston Court #302, Manassas, VA, 20112, US

(21) Appl. No.: 12/327,964

(22) Filed: Dec. 4, 2008

(51) Int. Cl. F16B 23/00; F16B 35/04

(52) U.S. Cl. 411/408; 411/411

(57) ABSTRACT

An improved hexagonal screw head being shaped on a top end of a threaded shank, wherein six edges of the hexagonal screw head are formed concave arc shapes caved in toward a center of the hexagonal screw head; thereby the six corners of the hexagonal screw head are shaped as sharp corners to provide better supporting strength against being easily damaged.

### BACKGROUND OF THE INVENTION

1. Field of the Invention

The present invention relates to an improved hexagonal screw head, and especially to a hexagonal screw head applicable to small screws of which the six edges are formed to have concave arc shapes in order to reduce corner damage.

2. Description of the Prior Art

FIG. 1 shows a conventional hexagonal screw 90, it is composed mainly of a hexagonal screw head 91 and a threaded shank 92. In locking together two parts, the hexagonal screw head 91 is exerted with a rotational twisting force, the two parts can then be locked together tight.

A conventional hexagonal screw head 91 is regular hexagonal, its six edges are all straight edges, when it is subjected to a rotational twisting force, its corners bear the largest components of the force and are subjected to damaging normally.

When small screws must be used in some specific circumstances, the corners of a hexagonal screw head are more easily damaged. Such as in a tooth implanting surgical operation, a hexagonal screw head is used to lock tight an implant root and an abutment; if the corners of the hexagonal screw head are destroyed, they are unable to well fix the abutment, this will make failure of the surgical operation.

Therefore, it is the main category of discussion of the present invention to provide an improved hexagonal screw head to reduce corner damage.

### SUMMARY OF THE INVENTION

Therefore, the present invention provides an improved hexagonal screw head which is shaped on the top end of a threaded shank, six edges of the hexagonal screw head are formed concave arc shapes caved in toward the center of the hexagonal screw head. Thereby, the six corners of the hexagonal screw head are shaped as sharp corners to provide better supporting strength against being easily damaged.

And more, the present invention provides a hexagonal screw having a small volume, being applicable to a small screw to be used for a tooth implanting surgical operation to lock tight an implant root and an abutment.

The present invention will be apparent in its structural features and effect of use after reading the detailed description of the preferred embodiment in reference to the accompanying drawings.

### BRIEF DESCRIPTION OF THE DRAWINGS

FIG. 1 is a perspective view showing the appearance of a conventional hexagonal screw;

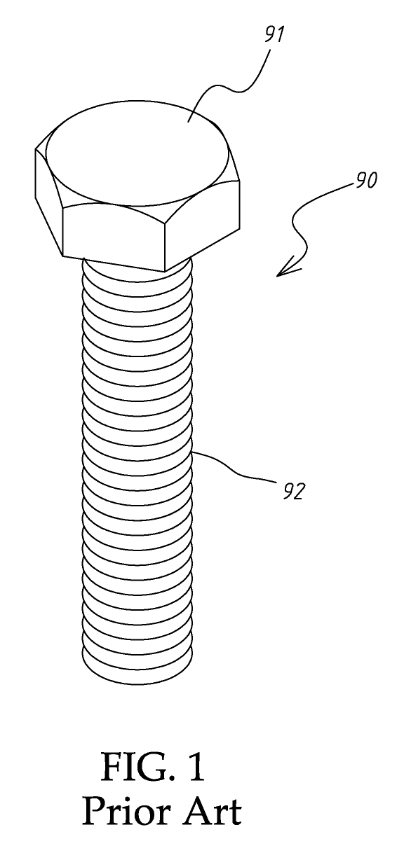

FIG. 2 is a perspective view showing the appearance of the present invention;

FIG. 3 is a bottom view of the present invention;

FIG. 4 is a sectional view showing application of the present invention to a tooth implanting surgical operation.

### DETAILED DESCRIPTION OF THE PREFERRED EMBODIMENT

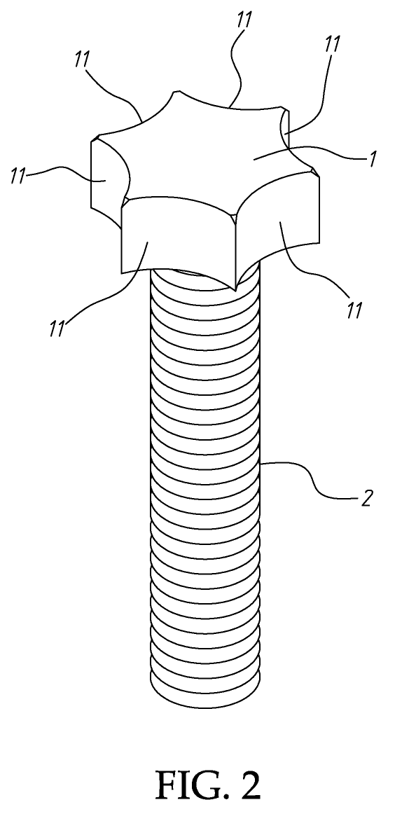

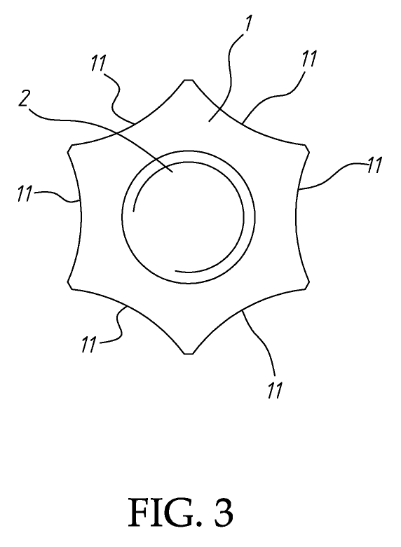

Referring to FIGS. 2 and 3, an improved hexagonal screw head 1 of the present invention is shaped on the top end of a threaded shank 2, six edges of the hexagonal screw head 1 are formed to have the shapes of concave arcs 11 caved in toward the center of the hexagonal screw head 1. We can see in the drawings that the six edges are all formed to have the shapes of concave arcs 11, but an alternative case is, at least one edge is caved in toward the center of the hexagonal screw head 1 to form the shape of a concave arc 11, or some of the edges mutually symmetrically located are formed to have the shapes of concave arcs 11.

By virtue that some edges of the hexagonal screw head 1 have concave arcs 11 caved in toward the center, so that when the hexagonal screw head 1 is exerted with a rotational twisting force, six corners of the hexagonal screw head 1 will get better supporting strength against being easily damaged, namely, they can bear larger rotational twisting force.

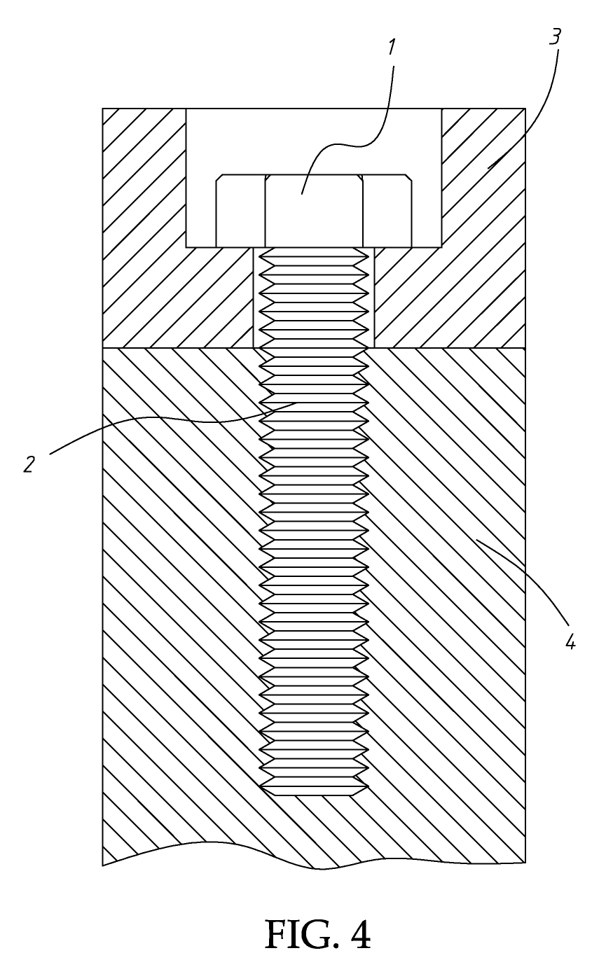

Particularly, when in using a small screw, such as using in a tooth implanting surgical operation to connect an implant root 4 with an abutment 3 as is shown in FIG. 4, by virtue that the volume covering the threaded shank 2 and the hexagonal screw head 1 is very small, the hexagonal screw head 1 which has its six edges caved in renders its six corners not to be subjected to being damaged, the surgical operation can thus progress smoothly. Certainly, the present invention can also be applied to other small screws to reduce the case of accidentally destroying their hexagonal screw heads.

In conclusion, according to the description disclosed above, the present invention provides an improved hexagonal screw head that can reduce the case destroying its corners of the hexagonal screw head, the hexagonal screw head can especially be applied to a small screw to reduce the case of accidentally destroying the hexagonal screw head.

Having now particularly described and ascertained the novelty and improvement of my invention and in what manner the same is to be performed, what we claim will be declared in the claims followed.

1. An improved hexagonal screw head being shaped on a top end of a threaded shank, at least one of six edges of said hexagonal screw head are formed concave arc shape caved in toward a center of said hexagonal screw head.

2. The improved hexagonal screw head as in claim 1, wherein said six edges each has an identical concave arc shape caved in toward said center of said hexagonal screw head.

3. A hexagonal screw being used in a tooth implanting surgical operation to connect an implant root with an abutment and comprising:
a threaded shank; and
a hexagonal screw head shaped on a top end of said threaded shank, at least one of six edges of said hexagonal screw head being formed concave arc shape caved in toward a center of said hexagonal screw head.

4. The as in claim 3, wherein said six edges each has an identical concave arc shape caved in toward said center of said hexagonal screw head.
